(19) United States
(12) Patent Application Publication
(10) Pub. No.: US 2026/0210076 A1
(43) Pub. Date: Jul. 23, 2026

(54) WORKING MACHINE

(71) Applicant: Yanmar Holdings Co., Ltd., Osaka (JP)

(72) Inventors: Tatsuo Yamasaki, Chikugo (JP); Hiromu Nagata, Chikugo (JP)

(73) Assignee: Yanmar Holdings Co., Ltd., Osaka (JP)

(21) Appl. No.: 19/557,141

(22) Filed: Mar. 5, 2026

(30) Foreign Application Priority Data
Jan. 23, 2025 (JP) 2025-009913

(51) Int. Cl. E02F 9/16; E02F 9/08

(52) U.S. Cl. CPC E02F 9/163; E02F 9/0858

(57) ABSTRACT

There is provided a working machine capable of reducing, even when an operator sitting on a driver's seat stretches his or her hand, a possibility that the stretched hand comes into contact with a receiving device. The working machine includes: a pair of pillars that supports a canopy portion from a rear side of a driver's seat, the canopy portion being disposed above the driver's seat of a driving section provided on one side of a machine body in a right-left direction; and a receiving device provided on the rear side relative to the pair of pillars. The pair of pillars includes: a first pillar disposed on the one side; and a second pillar disposed on the other side in the right-left direction relative to the first pillar. The receiving device is disposed to be offset to the other side from the rear side of the second pillar, and is disposed apart from the second pillar.

### CROSS-REFERENCE

This application claims foreign priority of JP 2025-009913 filed Jan. 23, 2025, the disclosures of which is hereby incorporated by reference in its entirety.

### TECHNICAL FIELD

The present invention relates to a working machine.

### BACKGROUND ART

Hitherto, as a working machine such as a hydraulic excavator, for example, a construction machine of Patent Document 1 has been known. In the above-mentioned construction machine, positional information on a blade transmitted from external surveying equipment is received by a receiver. The receiver is attached to a pillar of a canopy.

### PRIOR ART DOCUMENT

### Patent Document

Patent Document 1: JP2021-6696 A

### SUMMARY OF INVENTION

### Technical Problem

The pillar of the canopy is provided in the vicinity of a rear portion of a driver's seat. Accordingly, depending on how the receiver is mounted to the pillar, there is a possibility that, when an operator sitting on the driver's seat stretches his or her hand, the stretched hand comes into contact with the receiver.

The present invention has been made to solve the above-mentioned problem, and has an object to provide a working machine capable of reducing, even when an operator sitting on a driver's seat stretches his or her hand, such a possibility that the stretched hand comes into contact with a receiver (a receiving device).

### Solution to Problem

A working machine according to one aspect of the present invention includes: a pair of pillars that supports a canopy portion from a rear side of a driver's seat, the canopy portion being disposed above the driver's seat of a driving section provided on one side of a machine body in a right-left direction; and a receiving device provided on the rear side relative to the pair of pillars, wherein: the pair of pillars includes a first pillar disposed on the one side, and a second pillar disposed on an other side in the right-left direction relative to the first pillar; and the receiving device is disposed to be offset to the other side from the rear side of the second pillar and is disposed apart from the second pillar.

### Advantageous Effects of Invention

It is possible to reduce, even when the operator sitting on the driver's seat stretches his or her hand, the possibility that the stretched hand comes into contact with the receiving device.

### BRIEF DESCRIPTION OF DRAWINGS

FIG. 1 is a side view illustrating a schematic configuration of a hydraulic excavator that is an example of a working machine of the present invention;

FIG. 2 is a block diagram illustrating an electrical configuration for performing blade machine control;

FIG. 3 is a perspective view illustrating a configuration of a front side of a lower traveling body of the above-mentioned hydraulic excavator;

FIG. 4 is a back view of an upper revolving body of the above-mentioned hydraulic excavator as viewed from a rear side;

FIG. 5 is a plan view of the above-mentioned upper revolving body;

FIG. 6 is a plan view of the above-mentioned upper revolving body in a state in which illustration of a part of the configuration of FIG. 5 is omitted;

FIG. 7 is a plan view illustrating the vicinity of a right pillar of the above-mentioned upper revolving body in an enlarged manner;

FIG. 8 is a plan view illustrating the vicinity of the above-mentioned right pillar in an enlarged manner in a state in which illustration of a part of the configuration of FIG. 7 is omitted;

FIG. 9 is a perspective view of a driving section of the above-mentioned hydraulic excavator as viewed from a left rear side;

FIG. 10 is a perspective view of a first bracket in a state in which a receiving device and a communication gateway are attached;

FIG. 11 is an exploded perspective view of the above-mentioned receiving device, the above-mentioned communication gateway, and the above-mentioned first bracket;

FIG. 12 is an exploded perspective view illustrating a state before the above-mentioned first bracket is attached to an upper surface portion of a machine room of the above-mentioned hydraulic excavator;

FIG. 13 is a perspective view of the above-mentioned right pillar as viewed from a right front side; and

FIG. 14 is an exploded perspective view illustrating a state before a communication device is attached to a second bracket.

### DESCRIPTION OF EMBODIMENTS

An embodiment of the present invention is described below with reference to the drawings.

### 1. Outline of Working Machine

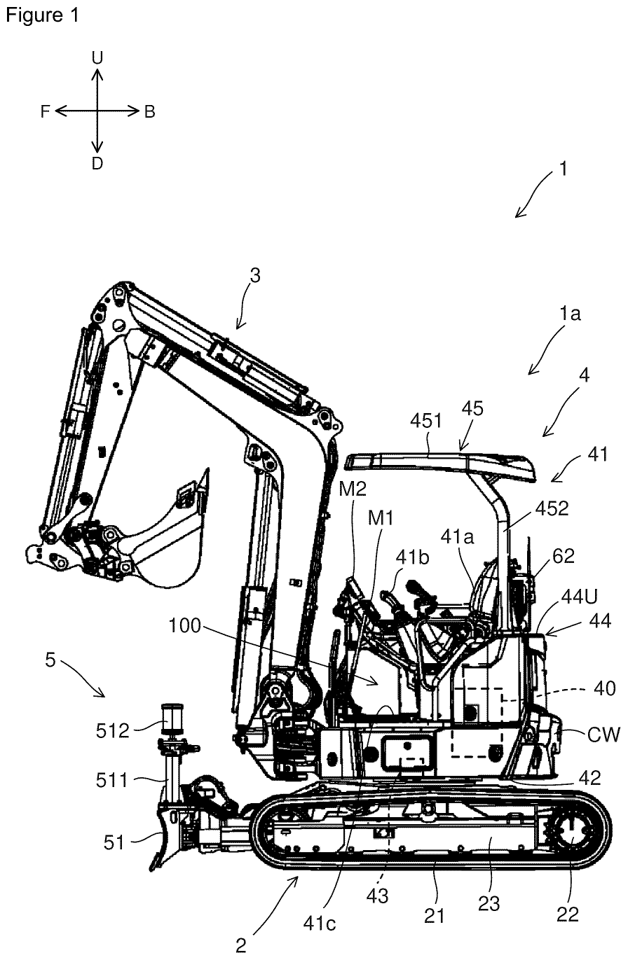

FIG. 1 is a side view illustrating a schematic configuration of a hydraulic excavator 1 that is an example of a working machine of the present embodiment. The hydraulic excavator 1 includes a lower traveling body 2, working equipment 3, and an upper revolving body 4.

Here, directions are described herein based on the following definitions. First, a direction in which an operator (an operating person, a driver) sitting on a driver's seat 41a of the upper revolving body 4 faces front is defined as a front side, and a direction opposite thereto is defined as a rear side. Accordingly, in a state in which the upper revolving body 4 does not revolve (a revolving angle of 0°) with respect to the lower traveling body 2, a front-rear direction of the upper revolving body 4 matches a direction in which the lower traveling body 2 moves forward and rearward. Further, the left side as viewed from the operator sitting on the driver's seat 41a is defined as “left”, and the right side is defined as “right”. Moreover, the gravity direction perpendicular to the front-rear direction and the right-left direction is defined as an up-down direction, an upstream side in the gravity direction is defined as “up”, and a downstream side is defined as “down”. The figures illustrate the hydraulic excavator 1 in a state in which the upper revolving body 4 does not revolve with respect to the lower traveling body 2. Further, in the figures, as required, the front side, the rear side, the left side, the right side, the upper side, and the lower side are represented by symbols of “F”, “B”, “L”, “R”, “U”, and “D”, respectively.

Herein, the lower traveling body 2 and the upper revolving body 4 are sometimes collectively referred to as a machine body 1a. Further, herein, unless particularly noted, description is given assuming that one side in the right-left direction is the left side, and the other side in the right-left direction is the right side. Note that the relation between the one side and the other side may be reversed. That is, the one side in the right-left direction may be the right side, and the other side may be the left side.

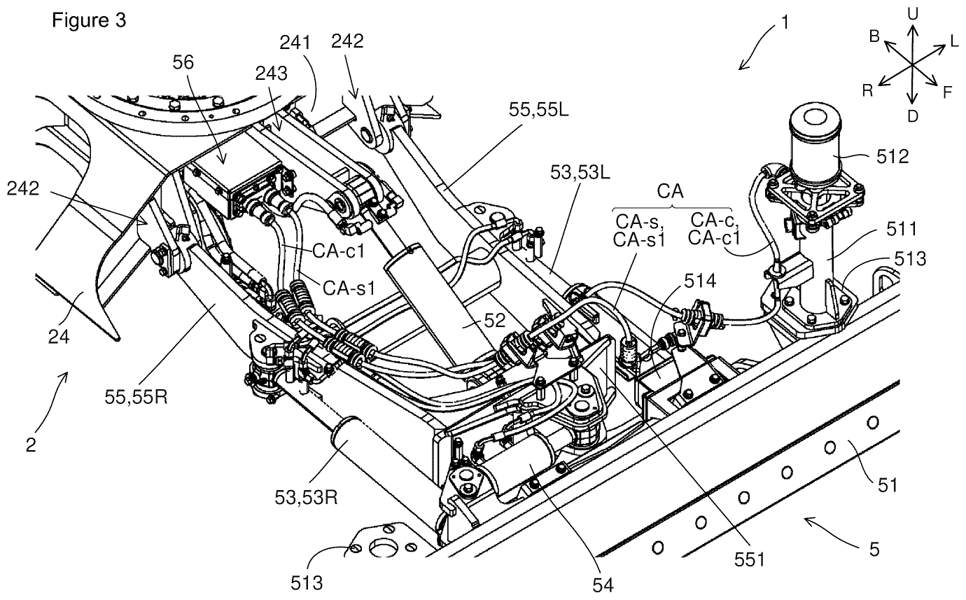

The lower traveling body 2 is a support body (lower body) that supports the upper revolving body 4. The lower traveling body 2 includes a pair of right and left crawlers 21, and a pair of right and left traveling motors 22. Each of the traveling motors 22 is a hydraulic motor. The hydraulic excavator 1 can move forward and rearward by the right and left traveling motors 22 respectively driving the right and left crawlers 21. The right and left traveling motors 22 are respectively supported by right and left side frames 23. The side frames 23 extend in the front-rear direction, and are disposed on both right and left sides of a center frame 24 (see FIG. 3) so as to be supported by the center frame 24.

In front of the machine body 1a, more specifically, on the front side of the lower traveling body 2, a soil-removing device 5 for performing ground leveling is provided. The soil-removing device 5 includes a blade 51. On the left side of the blade 51, a target prism 512 is provided via a pole 511. The target prism 512 is provided to achieve blade machine control. Note that details of the blade machine control including the target prism 512 are described later.

The working equipment 3 is a working device that performs excavation work for earth and sand or the like. The working equipment 3 is provided on a front portion of the upper revolving body 4, and turns in the up-down direction or the front-rear direction to perform the excavation work.

In the present embodiment, the working equipment 3 has a crane function. The crane function refers to a function of raising and lowering a suspended load. In order to achieve such a crane function, the working equipment 3 includes a hook (not shown). The above-mentioned hook is provided to allow a change in posture between a stored state and a deployed state. With the hook being deployed, a suspended load can be suspended by the hook via a chain or the like.

The upper revolving body 4 is an upper body positioned above the lower traveling body 2. The upper revolving body 4 is supported to be revolvable with respect to the lower traveling body 2. In the upper revolving body 4, a driving section 41, a revolving frame 42, a revolving motor 43, and a machine room 44 are disposed. The upper revolving body 4 is revolved via a revolving bearing (not shown) through drive of the revolving motor 43 that is a hydraulic motor. Inside the upper revolving body 4 (in particular, the machine room 44), a plurality of hydraulic pumps (not shown) are disposed in addition to an engine 40 that provides power to each portion. Further, at a rear portion of the upper revolving body 4, a counterweight CW is provided to maintain balance with the working equipment 3 in the front-rear direction.

Each hydraulic pump supplies hydraulic oil (pressure oil) via a hydraulic pipe to a hydraulic motor (for example, the right and left traveling motors 22 and the revolving motor 43) and a hydraulic cylinder. The above-mentioned hydraulic cylinder includes a lift cylinder 52 to be described later (see FIG. 3) or the like. The above-mentioned hydraulic motor and hydraulic cylinder to be driven by being supplied with the hydraulic oil from any hydraulic pump are collectively referred to as a hydraulic actuator.

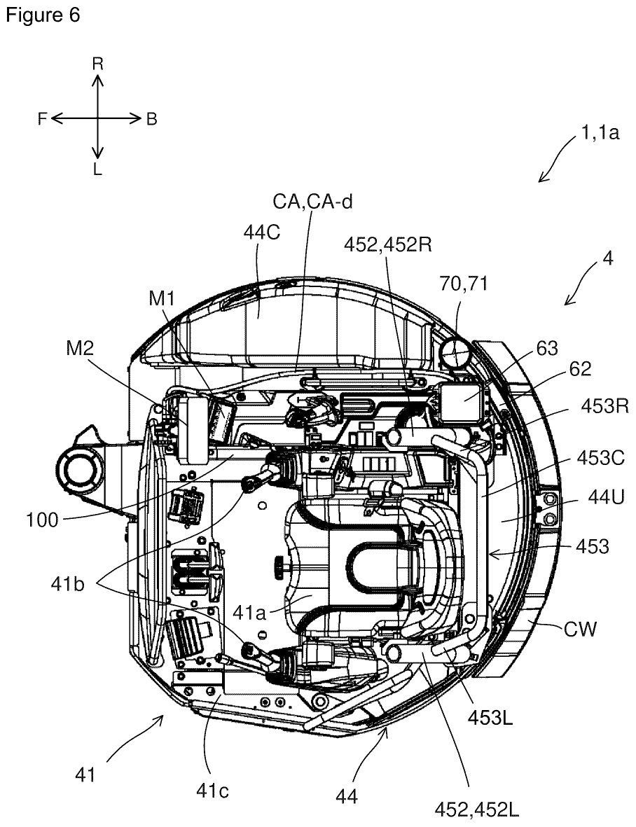

The driver's seat 41a is disposed in the driving section 41. Various operation levers 41b are disposed around the driver's seat 41a. Further, a getting on/off section 41c is provided on the left side of the driving section 41 (see also FIG. 6). The getting on/off section 41c is a part (entrance/exit) that becomes a passage when the operator gets on or off the driving section 41. The operator gets on the driving section 41 from the getting on/off section 41c and sits on the driver's seat 41a to operate the operation lever 41b so that a predetermined hydraulic actuator is driven. After the work by the hydraulic excavator 1 is completed, the operator passes through the getting on/off section 41c to get off the driving section 41.

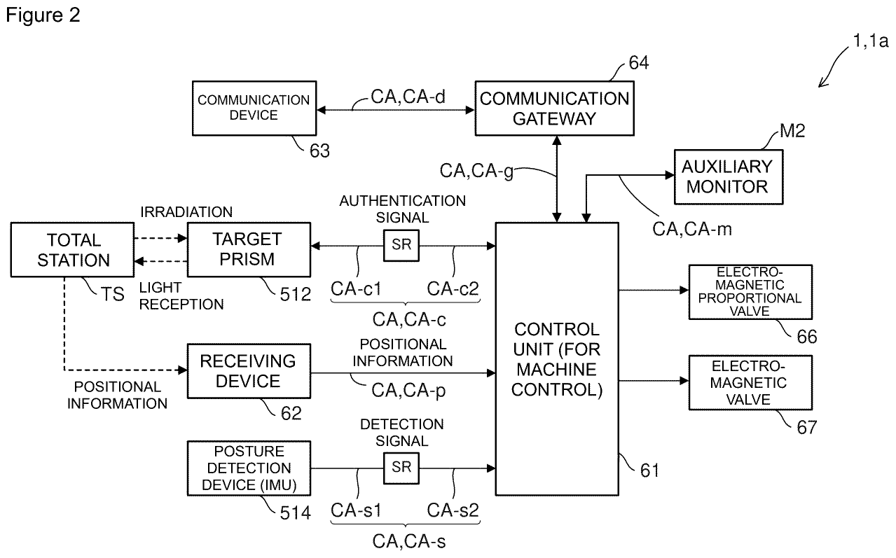

An accommodating section 100 is disposed on the right side of the driving section 41 and on the front side relative to the driver's seat 41a. The accommodating section 100 is a box body. In the accommodating section 100, a control unit 61 that performs blade machine control and is to be described later (see FIG. 2) and the like are accommodated.

In the driving section 41, above the accommodating section 100, a main monitor M1 and an auxiliary monitor M2 are disposed. The main monitor M1 and the auxiliary monitor M2 display various types of information. For example, on the main monitor M1, various settings in the hydraulic excavator 1, the remaining amount of fuel, an hour meter, an image taken by a monitoring camera when the monitoring camera is installed, and the like are displayed. On the auxiliary monitor M2, information presented to the operator when the blade machine control is performed is displayed. The above-mentioned information includes, for example, information representing the construction surface and the position of the blade 51.

The driving section 41 includes a canopy 45. The canopy 45 is provided upright at an upper rear portion of the machine room 44, and covers at least the upper side of the driver's seat 41a. In more detail, the canopy 45 includes a canopy portion 451 and a pillar 452. The canopy portion 451 is disposed above the driver's seat 41a of the driving section 41. The pillar 452 is provided on an upper surface portion 44U of the machine room 44. The upper surface portion 44U is provided on the rear side of the driver's seat 41a. The pillar 452 extends upward from the upper surface portion 44U, and then is bent forward to extend up to the canopy portion 451 to support the canopy portion 451. That is, the pillar 452 supports the canopy portion 451 from the rear side of the driver's seat 41a.

Two pillars 452 are provided apart from each other in the right-left direction on the upper surface of the machine room 44. That is, the hydraulic excavator 1 includes a pair of pillars 452 arranged in the right-left direction. Such a canopy 45 is also called a two-pillar canopy. Note that the canopy 45 may have a configuration in which the canopy portion 451 is supported with three or more pillars 452.

### 2. Blade Machine Control

FIG. 2 is a block diagram for illustrating an electrical configuration for performing blade machine control in the hydraulic excavator 1. FIG. 3 is a perspective view illustrating a configuration of the front side of the lower traveling body 2.

Blade machine control refers to control of automatically adjusting the posture (a height position, an angle) of the blade 51 based on three-dimensional data of the ground to be constructed and positional information on the blade 51. In the following, the blade machine control is also simply called machine control. In the present embodiment, in order to achieve such machine control, the hydraulic excavator 1 includes the above-mentioned target prism 512.

The target prism 512 is configured of a 360-degree prism. The 360-degree prism can reflect light in a direction parallel to incident light even when light enters the 360-degree prism from any direction. The target prism 512 becomes a target for which the position is measured by a total station TS to be described later. The target prism 512 is attached to the upper portion of the pole 511, and is mounted to the blade 51 via the pole 511.

As illustrated in FIG. 3, the above-mentioned pole 511 is attached to an upper surface of an attachment stage 513 by using a fastening member such as a bolt. The attachment stage 513 is provided at two portions by welding or the like in the vicinity of the right end and the vicinity of the left end of the blade 51. Accordingly, the pole 511 can be selectively attached to any one of the right and left attachment stages 513 in a state of holding the target prism 512. As illustrated in FIG. 3, the present embodiment shows an example in which the pole 511 is attached to the left attachment stage 513, but the pole 511 may be attached to the right attachment stage 513.

At the work site of the hydraulic excavator 1 or in the vicinity thereof, the total station TS (see FIG. 2) is installed. The total station TS is configured of a publicly-known electronic distance and angle measuring device using light. The total station TS irradiates the target prism 512 with light and receives the light reflected by the target prism 512, to thereby measure a vertical angle, a horizontal angle, and a distance at which the target prism 512 is positioned. This allows three-dimensional positional coordinates of the target prism 512 to be acquired by calculation.

The total station TS is configured as an automatic tracking type, and has a function of automatically tracking the change in position of the target prism 512. The total station TS acquires the change in position of the target prism 512 in real time while tracking the target prism 512. A relative positional relationship between the target prism 512 and the blade 51 is fixed. This allows the total station TS to acquire the positional coordinates (positional information) of the target prism 512 to acquire the positional information on the blade 51 on which the target prism 512 is mounted.

In the hydraulic excavator 1, the control unit 61 illustrated in FIG. 2 is provided. The control unit 61 is a controller for machine control, and is configured of, for example, an electronic control unit called an ECU. The control unit 61 can acquire the positional information on the target prism 512 (the positional information on the blade 51) acquired by the total station TS, via a receiving device 62 including an antenna or the like.

The above-mentioned target prism 512 is connected to the control unit 61 via an authentication cable CA-c. Between the target prism 512 and the control unit 61, transmission and reception of an authentication signal are performed via the authentication cable CA-c. This allows the control unit 61 to reliably receive only positional information from a specific total station TS via the receiving device 62. Communication between the total station TS and the receiving device 62 is performed in a wireless manner, for example. The signal (the above-mentioned positional information) received by the receiving device 62 is transmitted to the control unit 61 via a positional information transmission cable CA-p. Each of the authentication cable CA-c and the positional information transmission cable CA-p is one type of a cable CA.

The authentication cable CA-c includes a first authentication cable CA-c1 and a second authentication cable CA-c2. The first authentication cable CA-c1 connects the target prism 512 and a slip ring SR via a relay portion 56 (see FIG. 3). The relay portion 56 is fixed to a front wall portion 241 of the center frame 24 by using a fastening member such as a bolt. The slip ring SR is provided at a middle portion of the center frame 24, and transmits an electrical signal between the lower traveling body 2 and the upper revolving body 4. The second authentication cable CA-c2 is provided on the upper revolving body 4 to connect the slip ring SR and the control unit 61.

As described above, the control unit 61 is accommodated in the accommodating section 100. Accordingly, a part of the second authentication cable CA-c2 and a part of the positional information transmission cable CA-p connected to the control unit 61 are also accommodated in the accommodating section 100. That is, the second authentication cable CA-c2 and the positional information transmission cable CA-p are routed to pass through the accommodating section 100.

The hydraulic excavator 1 further includes a posture detection device 514. The posture detection device 514 is configured of, for example, an inertial measurement device (IMU: Inertial Measurement Unit). The inertial measurement device is a device including a three-axis gyroscope sensor and a three-directional accelerometer.

As illustrated in FIG. 3, the posture detection device 514 is mounted at a rear portion of the blade 51. In the present embodiment, the posture detection device 514 is mounted on the target prism 512 side (the left side) relative to the middle of the blade 51 in the right-left direction. The posture detection device 514 can detect a position in the right-left direction, the front-rear direction, and the up-down direction (a three-dimensional position) and the acceleration of the blade 51. Further, based on the information on the above-mentioned acceleration, an inclination angle in the right-left direction, the front-rear direction, and the up-down direction of the blade 51 can be detected. That is, the posture of the blade 51 can be detected by the posture detection device 514.

As illustrated in FIG. 2, the posture detection device 514 is connected to the control unit 61 via a detection signal transmission cable CA-s. This allows the control unit 61 to acquire a detection signal output from the posture detection device 514, that is, posture information on the blade 51 via the detection signal transmission cable CA-s. The detection signal transmission cable CA-s is one type of the cable CA.

The detection signal transmission cable CA-s includes a first detection signal transmission cable CA-s1 and a second detection signal transmission cable CA-s2. The first detection signal transmission cable CA-s1 connects the posture detection device 514 and the slip ring SR via the relay portion 56. The second detection signal transmission cable CA-s2 is provided to the upper revolving body 4, and connects the slip ring SR and the control unit 61.

The control unit 61 is accommodated in the accommodating section 100, and hence a part of the second detection signal transmission cable CA-s2 connected to the control unit 61 is also accommodated in the accommodating section 100. That is, the second detection signal transmission cable CA-s2 is routed to pass through the accommodating section 100.

The hydraulic excavator 1 further includes a communication device 63. The communication device 63 includes, for example, a communication antenna that can transmit and receive a signal. This allows the communication device 63 to communicate with an external terminal device to receive (acquire) predetermined information from the above-mentioned terminal device. It is possible to consider, as the above-mentioned predetermined information, for example, three-dimensional data of the construction surface. The above-mentioned predetermined information acquired by the communication device 63 from the outside is transmitted to the control unit 61 via a communication gateway 64. Further, the information can be transmitted from the hydraulic excavator 1 to the outside via the communication device 63.

The communication gateway 64 is a relay device that relays communication between the communication device 63 and the control unit 61, and can be configured of, for example, an ECU. The communication device 63 and the communication gateway 64 are connected via a data transmission cable CA-d. Further, the communication gateway 64 and the control unit 61 are connected via a communication cable CA-g. As described above, the hydraulic excavator 1 includes the communication gateway 64 serving as an electrical component that communicates with predetermined equipment (for example, the communication device 63). Each of the data transmission cable CA-d and the communication cable CA-g is one type of the cable CA.

The communication device 63 and the communication gateway 64 are disposed at positions close to each other in the present embodiment (see, for example, FIG. 6; details of the disposing positions are described later). Meanwhile, the data transmission cable CA-d is configured of an elongated standard product. Accordingly, the data transmission cable CA-d extending from the communication device 63 is once introduced inside the accommodating section 100 in which the control unit 61 is accommodated, and then passes through the accommodating section 100 to be introduced to the communication gateway 64. Thus, a part of the data transmission cable CA-d is accommodated in the accommodating section 100. Further, a part of the communication cable CA-g connected to the control unit 61 is also accommodated in the accommodating section 100. That is, the data transmission cable CA-d and the communication cable CA-g are routed to pass through the accommodating section 100.

Moreover, the auxiliary monitor M2 is connected to the control unit 61 via a monitor cable CA-m. Information to be displayed on the auxiliary monitor M2 (for example, information indicating the construction surface and the position of the blade 51) is transmitted from the control unit 61 to the auxiliary monitor M2 via the monitor cable CA-m, and is displayed on the auxiliary monitor M2. The monitor cable CA-m is one type of the cable CA.

A part of the monitor cable CA-m is accommodated in the accommodating section 100 in which the control unit 61 is accommodated. That is, the monitor cable CA-m is routed to pass through the accommodating section 100.

The control unit 61 includes a storage unit. The control unit 61 operates in accordance with an operation program stored in the above-mentioned storage unit. The above-mentioned storage unit is a memory that stores various types of information, and is configured of, for example, a RAM (Random Access Memory), a ROM (Read Only Memory), a hard disk, an SSD (solid state drive), a non-volatile memory, and the like. The above-mentioned storage unit stores, for example, an operation program for machine control, received three-dimensional data of the construction surface, and the like.

Accordingly, the control unit 61 can execute the above-mentioned operation program to control a solenoid proportional valve 66 and a solenoid valve 67 based on the positional information on the target prism 512 (the positional information on the blade 51) acquired via the total station TS, the posture information on the blade 51 acquired from the posture detection device 514, and three-dimensional data of the construction surface.

The solenoid proportional valve 66 is provided to control a directional switching valve included in a control valve (not shown). The above-mentioned directional switching valve includes a directional switching valve for the lift cylinder 52 illustrated in FIG. 3, and a directional switching valve shared by an angle cylinder 53 and a tilt cylinder 54. The former directional switching valve for the lift cylinder 52 refers to a directional switching valve for controlling the flow rate and the flow direction of hydraulic oil supplied from a hydraulic pump (not shown) to the lift cylinder 52. The latter directional switching valve refers to a directional switching valve for controlling the flow rate and the flow direction of hydraulic oil supplied from the hydraulic pump to the angle cylinder 53 or the tilt cylinder 54. The angle cylinder 53 and the tilt cylinder 54 are connected to the solenoid valve 67 via different pipes.

The solenoid valve 67 is a switching valve for switching a supply destination of the hydraulic oil from the hydraulic pump to the angle cylinder 53 or the tilt cylinder 54. That is, the solenoid valve 67 switches an oil path to one of the angle cylinder 53 and the tilt cylinder 54 based on an electrical signal (control signal) from the control unit 61.

The lift cylinder 52 illustrated in FIG. 3 is a hydraulic cylinder that raises and lowers the blade 51 in the up-down direction. The angle cylinder 53 is a hydraulic cylinder that swings each of right and left end portions of the blade 51 in the front-rear direction. The tilt cylinder 54 is a hydraulic cylinder that swings each of the right and left end portions of the blade 51 in the up-down direction. Accordingly, the control unit 61 can control the solenoid proportional valve 66 and the solenoid valve 67 based on the positional information on the target prism 512 described above and the like to extend and retract at least any one of the lift cylinder 52, the angle cylinder 53, and the tilt cylinder 54. This makes it possible to automatically adjust the position of the blade 51 in the up-down direction, an inclination angle (angle) in the front-rear direction, and an inclination angle (tilt) in the right-left direction to move the blade 51 along the construction surface.

### 3. Support Structure for Blade

Next, the support structure for the blade 51 is described. As illustrated in FIG. 3, the above-mentioned lift cylinder 52 is disposed between a pair of right and left arms 55, that is, between a left arm 55L and a right arm 55R. The left arm 55L and the right arm 55R are attached to the lower traveling body 2 and extend forward.

In more detail, an arm support portion 242 is provided to the front wall portion 241 of the center frame 24 of the lower traveling body 2. The arm support portion 242 has a structure in which the arm 55 is sandwiched between a pair of plate-shaped members so that the arm 55 is supported to be turnable in the up-down direction. Arm support portions 242 are provided to protrude forward from positions different in the right-left direction in the front wall portion 241. The left arm 55L and the right arm 55R are respectively supported by the right and left arm support portions 242 to extend to the blade 51 side on the front side. Distal ends of the left arm 55L and the right arm 55R are respectively coupled to a left end portion and a right end portion of a coupling portion 551 extending in the right-left direction. The blade 51 is disposed on the front side of the coupling portion 551, and is attached to the coupling portion 551 so as to be turnable via a turning axis extending in the front-rear direction.

At a middle portion in the right-left direction in the front wall portion 241, a lift cylinder support portion 243 is provided. The lift cylinder support portion 243 is disposed between the right and left arm support portions 242, and is provided to protrude forward from the front wall portion 241. The right and left arm support portions 242 are provided at positions symmetrical in the right-left direction with respect to the lift cylinder support portion 243.

The lift cylinder support portion 243 has a structure in which one end portion (for example, a rod end portion) of the lift cylinder 52 is sandwiched between a pair of plate-shaped members so that the lift cylinder 52 is supported to be turnable in the up-down direction. The other end portion of the lift cylinder 52 is supported by a back surface of the coupling portion 551 so as to be turnable in the up-down direction.

With the hydraulic oil being supplied/discharged (supplied or discharged) via a lift hydraulic hose to or from the lift cylinder 52, the lift cylinder 52 extends or retracts. This allows the blade 51 to be raised and lowered in the up-down direction.

The angle cylinder 53 includes a right angle cylinder 53R and a left angle cylinder 53L. The right angle cylinder 53R is disposed on the right side of the right arm 55R. One end portion (a rod-side end portion) of the right angle cylinder 53R is supported by the right arm 55R. The other end portion (a bottom-side end portion) of the right angle cylinder 53R is supported by the back surface of the blade 51 at a position on the right side relative to the middle in the right-left direction.

The left angle cylinder 53L is disposed on the left side of the left arm 55L. One end portion (a rod-side end portion) of the left angle cylinder 53L is supported by the left arm 55L. The other end portion (a bottom-side end portion) of the left angle cylinder 53L is supported by the back surface of the blade 51 at a position on the left side relative to the middle in the right-left direction.

With the above-mentioned solenoid valve 67 (see FIG. 2), when the oil path from the hydraulic pump is switched to the angle cylinder 53 side (instead of the tilt cylinder 54 side), the hydraulic oil is supplied/discharged via a right angle hydraulic hose to or from the right angle cylinder 53R to extend or retract the right angle cylinder 53R. Further, the hydraulic oil is supplied/discharged via a left angle hydraulic hose to or from the left angle cylinder 53L to extend or retract the left angle cylinder 53L.

Note that the solenoid valve 67 and the right angle cylinder 53R are connected by the right angle hydraulic hose. Meanwhile, the left angle hydraulic hose is provided to branch from the right angle hydraulic hose and is connected to the left angle cylinder 53L. However, a connection destination (the bottom side and the rod side) of the right angle hydraulic hose with respect to the right angle cylinder 53R and a connection destination (the bottom side and the rod side) of the left angle hydraulic hose with respect to the left angle cylinder 53L are set such that, when the right angle cylinder 53R extends, the left angle cylinder 53L retracts, and when the right angle cylinder 53R retracts, the left angle cylinder 53L extends.

Accordingly, for example, when the right angle cylinder 53R retracts and the left angle cylinder 53L extends, the blade 51 is inclined to the right direction with respect to the direction of travel of the hydraulic excavator 1. That is, the blade 51 is inclined so that the left end is positioned on the front side relative to the right end. Conversely, when the right angle cylinder 53R extends and the left angle cylinder 53L retracts, the blade 51 is inclined to the left direction with respect to the direction of travel of the hydraulic excavator 1. That is, the blade 51 is inclined so that the right end is positioned on the front side relative to the left end.

In the present embodiment, the number of angle cylinders 53 is two (the left angle cylinder 53L and the right angle cylinder 53R), but only one of the right and left angle cylinders may be provided. However, from the viewpoint of turning the blade 51 in the front-rear direction with good balance, as in the present embodiment, the number of angle cylinders 53 is desirably two.

The tilt cylinder 54 is disposed between the coupling portion 551 and the blade 51, and extends and retracts in the right-left direction. One end portion (for example, a left end portion) of the tilt cylinder 54 is supported on a front surface portion of the coupling portion 551 at a position above the turning axis (extending in the front-rear direction) of the blade 51. The other end portion (for example, a right end portion) of the tilt cylinder 54 is supported on the back surface of the blade 51 at a position on the right side relative to the middle in the right-left direction.

The tilt cylinder 54 and the solenoid valve 67 are connected by a tilt hydraulic hose. When the oil path from the hydraulic pump is switched to the tilt cylinder 54 side (instead of the angle cylinder 53 side) with the solenoid valve 67, the hydraulic oil is supplied/discharged via the tilt hydraulic hose from the solenoid valve 67 to the tilt cylinder 54 to extend or retract the tilt cylinder 54. When the tilt cylinder 54, for example, extends, the blade 51 turns in a direction in which the right end is lowered and the left end is raised. Conversely, when the tilt cylinder 54 retracts, the blade 51 turns in a direction in which the right end is raised and the left end is lowered.

### 4. Supplements to Configuration of Upper Revolving Body

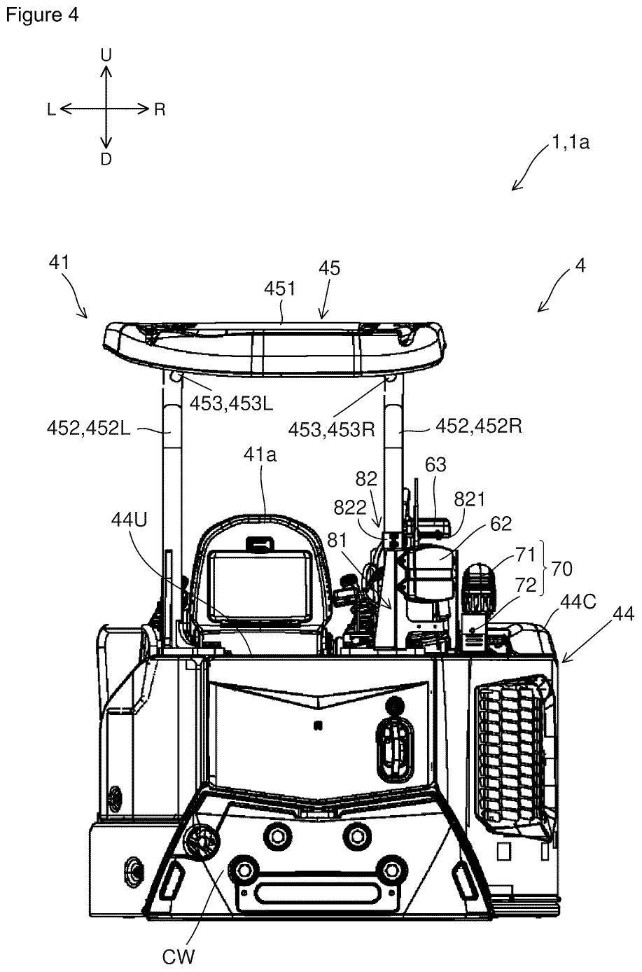

Next, supplements to the description of the configuration of the upper revolving body 4 described above are given. FIG. 4 is a back view of the upper revolving body 4 as viewed from the rear side. As illustrated in the same figure, the driving section 41 is provided in the upper revolving body 4 closer to the left side from the middle position in the right-left direction. That is, the driving section 41 is provided on the one side in the right-left direction of the machine body 1a (the upper revolving body 4).

A cover member 44C is provided on the other side in the right-left direction of the machine body 1a, that is, the right side of the driving section 41. The cover member 44C is provided to be turnable in the up-down direction with the use of the rear end as a turning fulcrum. With the cover member 44C being turned and opened, maintenance of components accommodated therein can be performed. Examples of the above-mentioned components include a hydraulic oil tank and a low-voltage battery, but the above-mentioned components are not limited to those components.

Further, the pair of pillars 452 of the canopy 45 includes a left pillar 452L and a right pillar 452R. The left pillar 452L is disposed on the left side in the driving section 41, and supports the left side of the canopy portion 451. The right pillar 452R is disposed on the right side relative to the left pillar 452L, and supports the right side of the canopy portion 451. As described above, the pair of pillars 452 includes the left pillar 452L serving as a first pillar disposed on the one side in the right-left direction, and the right pillar 452R serving as a second pillar disposed on the other side in the right-left direction relative to the left pillar 452L.

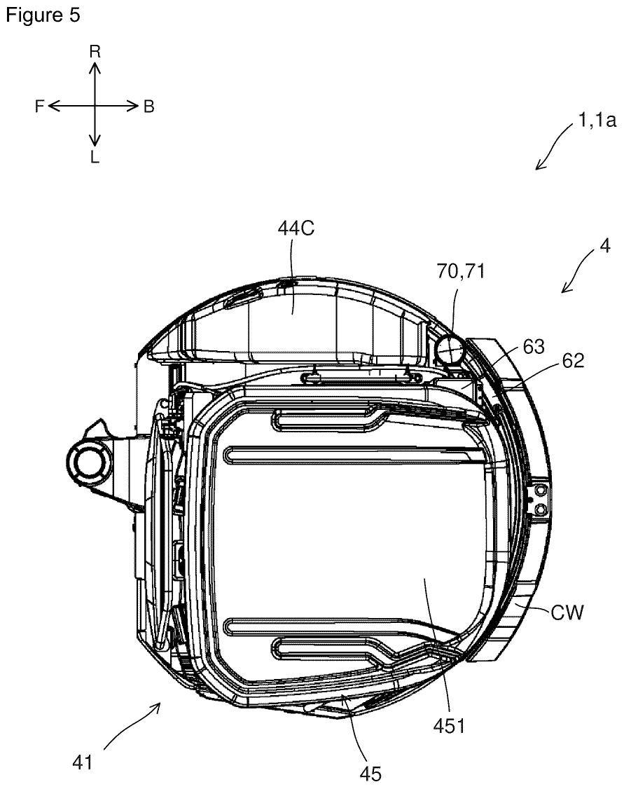

FIG. 5 is a plan view of the upper revolving body 4. FIG. 6 is a plan view of the upper revolving body 4 in a state in which illustration of the canopy portion 451 of the canopy 45 is omitted in FIG. 5. The above-mentioned left pillar 452L and right pillar 452R are coupled by a horizontal pillar 453. The horizontal pillar 453 couples the left pillar 452L and the right pillar 452R at upper portions thereof. This prevents a rear field of view of the operator sitting on the driver's seat 41a from being blocked by the horizontal pillar 453, and the field of view is satisfactorily ensured.

The horizontal pillar 453 includes a middle portion 453C, a left coupling portion 453L, and a right coupling portion 453R. The middle portion 453C extends in the right-left direction. The left coupling portion 453L extends from a left end of the middle portion 453C diagonally forward left to be coupled to the left pillar 452L. The right coupling portion 453R extends from a right end of the middle portion 453C diagonally forward right to be coupled to the right pillar 452R. With the horizontal pillar 453 being provided, the left pillar 452L and the right pillar 452R are reinforced. This allows the canopy portion 451 to be stably supported by the left pillar 452L and the right pillar 452R.

In the upper surface portion 44U of the upper revolving body 4, an alarm device 70 is disposed on the right side relative to the right pillar 452R. That is, the hydraulic excavator 1 includes the alarm device 70 disposed on the other side in the right-left direction relative to the right pillar 452R serving as the second pillar. The alarm device 70 includes an alarm lamp 71 and an alarm buzzer 72.

The alarm lamp 71 is configured of, for example, a revolving light. The alarm lamp 71 is turned on in response to abnormality detection to give an alert to the surroundings. For example, the alarm lamp 71 is turned on when an overload is applied to the working equipment 3 in the crane work. The alarm buzzer 72 emits a sound when, for example, the hydraulic excavator 1 travels to give an alert to the surroundings at the time of travel. In the present embodiment, the alarm buzzer 72 is disposed on the upper surface portion 44U, and the alarm lamp 71 is disposed on the alarm buzzer 72. Note that, in the upper surface portion 44U, the alarm lamp 71 may be disposed next to the alarm buzzer 72.

### 5. Arrangement of Receiving Device and Communication Gateway

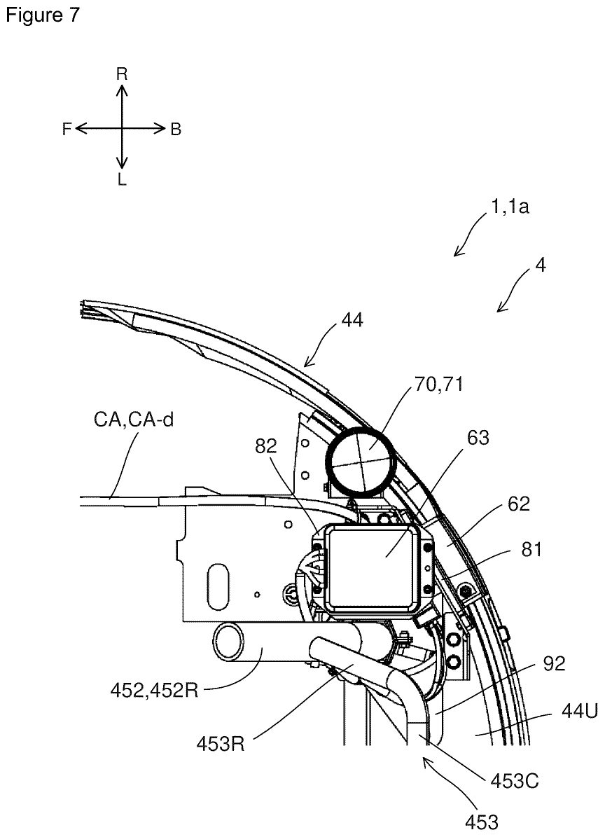

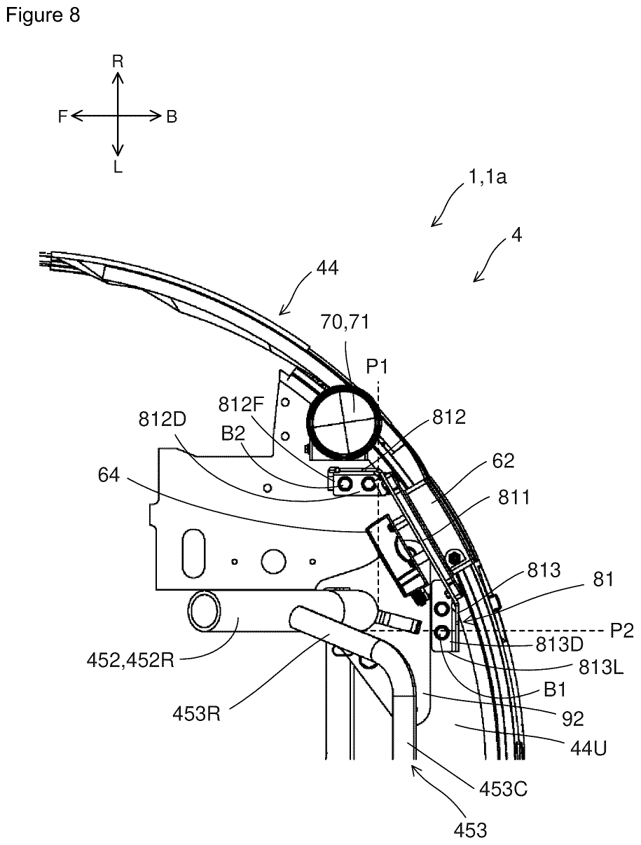

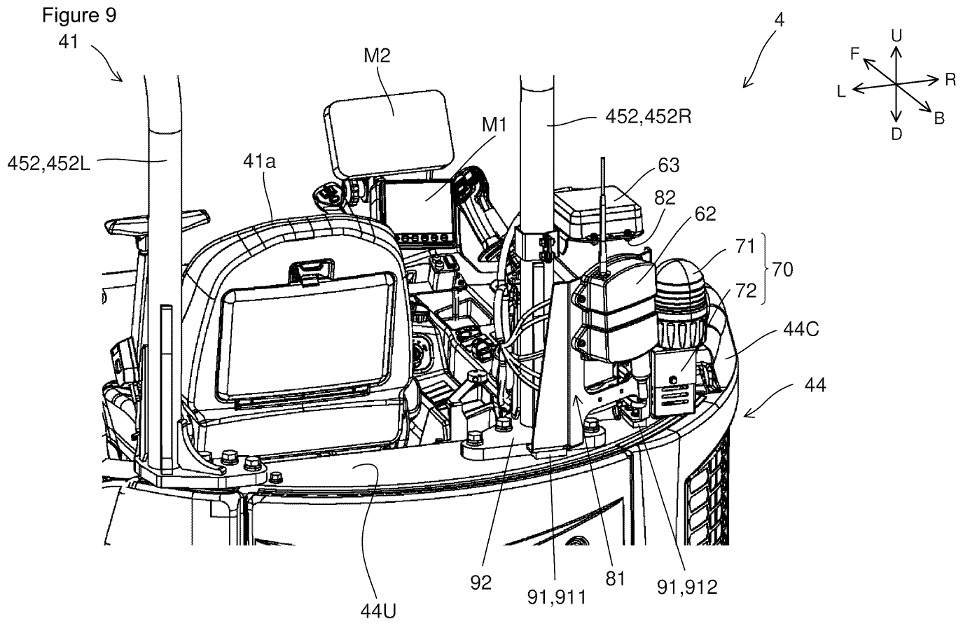

Next, the arrangement of the receiving device 62 and the communication gateway 64 described above is described. FIG. 7 is a plan view illustrating the vicinity of the right pillar 452R of the upper revolving body 4 in an enlarged manner. FIG. 8 is a plan view illustrating the vicinity of the right pillar 452R in an enlarged manner in a state in which illustration of the communication device 63, a second bracket 82, and the data transmission cable CA-d in FIG. 7 is omitted. FIG. 9 is a perspective view of the driving section 41 as viewed from a left rear side.

As illustrated in FIG. 6 to FIG. 9, the receiving device 62 included in the hydraulic excavator 1 is provided on the rear side relative to the pair of pillars 452. In more detail, as illustrated in FIG. 8, a rear end position of the right pillar 452R (and the left pillar 452L) is represented by P1. The receiving device 62 is disposed on the rear side relative to the rear end position P1.

Further, the receiving device 62 is disposed to be offset to the right side, that is, to the other side in the right-left direction, from the rear side of the right pillar 452R. In more detail, as illustrated in FIG. 8, a left end position of the right pillar 452R is represented by P2. The receiving device 62 is disposed on the right side relative to the left end position P2. That is, the receiving device 62 is disposed on the other side relative to the end portion of the right pillar 452R on the one side in the right-left direction. In the present embodiment, as illustrated in FIG. 4, a part of the receiving device 62 is disposed to overlap the right pillar 452R in back view. Note that the receiving device 62 may be disposed to be offset to the right side relative to the right end of the right pillar 452R.

Moreover, the receiving device 62 is disposed apart from the right pillar 452R (in plan view). More specifically, as illustrated in FIG. 6 to FIG. 9, the receiving device 62 is mounted to a first bracket 81. The first bracket 81 is fixed to the upper surface portion 44U via a first support portion 91 (see FIG. 9). Note that details of the first bracket 81 are described later. Meanwhile, the right pillar 452R is fixed to the upper surface portion 44U via a second support portion 92. With the receiving device 62 and the right pillar 452R being fixed to the upper surface portion 44U by different support portions (the first support portion 91 and the second support portion 92), the configuration in which the receiving device 62 and the right pillar 452R are disposed apart from each other is achieved.

In the arrangement of the receiving device 62 in the present embodiment, a distance between the operator sitting on the driver's seat 41a and the receiving device 62 is extended as compared to a configuration in which, for example, the receiving device 62 is attached to the right pillar 452R and a configuration in which the receiving device 62 is between the left pillar 452L and the right pillar 452R in back view. This prevents the hand of the operator from reaching the receiving device 62 even when the operator sitting on the driver's seat 41a stretches his or her hand. That is, it is possible to reduce such a possibility that the stretched hand of the operator comes into contact with the receiving device 62. Such an effect can be reliably obtained particularly when the receiving device 62 is disposed on the rear side relative to the right pillar 452R and on the right side relative to the left end position P2 of the right pillar 452R (see FIG. 8).

From the viewpoint of easily achieving the configuration in which the receiving device 62 is disposed at a position apart from the right pillar 452R, as illustrated in FIG. 8, the first bracket 81 is desirably disposed between the right pillar 452R and the receiving device 62 to be supported on the machine body 1a (the upper surface portion 44U). Further, even from the viewpoint of allowing the receiving device 62 to be stably supported (disposed) on the machine body 1a, the hydraulic excavator 1 desirably includes the first bracket 81 disposed as described above.

Hereinafter, details of the first bracket 81 are described. As illustrated in FIG. 8, in addition to the receiving device 62, the communication gateway 64 is attached to the first bracket 81. More specifically, the receiving device 62 is attached on the rear side relative to the first bracket 81. The communication gateway 64 is attached on the front side relative to the first bracket 81.

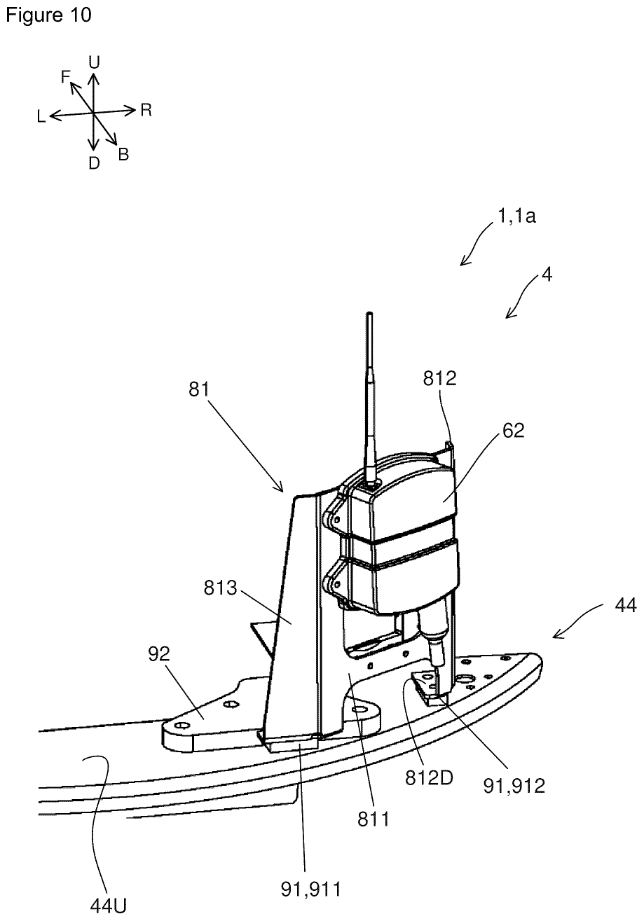

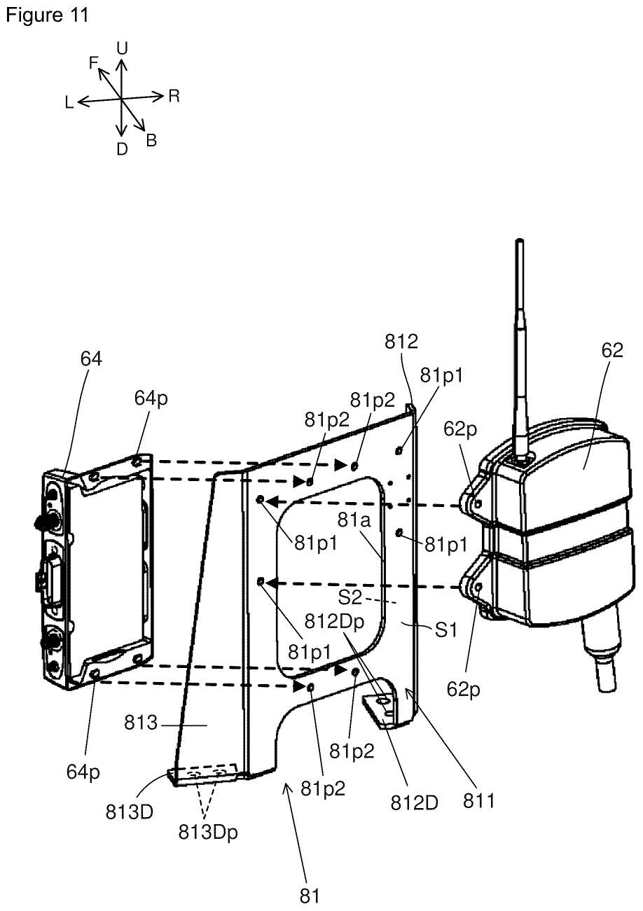

FIG. 10 is a perspective view of the first bracket 81 in a state in which the receiving device 62 and the communication gateway 64 are attached. FIG. 11 is an exploded perspective view of the receiving device 62, the communication gateway 64, and the first bracket 81. The first bracket 81 is formed, for example, by bending a flat plate made of metal. Specifically, the first bracket 81 is configured by coupling a flat plate portion 811, a first coupling portion 812, and a second coupling portion 813.

As illustrated in FIG. 8, the flat plate portion 811 is disposed to be inclined with respect to the front-rear direction. Specifically, the flat plate portion 811 is disposed so that a right end side (a coupling side to the first coupling portion 812) is positioned relatively forward and a left end side (a coupling side to the second coupling portion 813) is positioned relatively rearward. As illustrated in FIG. 11, an opening portion 81a is formed at the middle of the flat plate portion 811. A plurality of first through holes 81p1 are provided at predetermined positions around the opening portion 81a. Into each of the first through holes 81p1, a bolt (not shown) for fixing the receiving device 62 is inserted. The receiving device 62 is disposed on the rear side of the flat plate portion 811, and the bolt is inserted into an attachment hole 62p of the receiving device 62 and the first through hole 81p1 of the flat plate portion 811 and fixed by using a nut. This allows the receiving device 62 to be attached to the flat plate portion 811. That is, the receiving device 62 is mounted on the rear side of the first bracket 81. Note that, in the first bracket 81, a surface on which the receiving device 62 is mounted is referred to as a first surface S1.

Further, a plurality of second through holes 81p2 are provided at other positions around the opening portion 81a of the flat plate portion 811. Into each of the second through holes 81p2, a bolt (not shown) for fixing the communication gateway 64 is inserted. The communication gateway 64 is disposed on the front side of the flat plate portion 811, and the bolt is inserted into a through portion 64p serving as an attachment hole of the communication gateway 64 and the second through hole 81p2 and is fixed by using a nut. This allows the communication gateway 64 to be attached to the flat plate portion 811. That is, the communication gateway 64 is mounted on the front side of the first bracket 81. Note that, in the first bracket 81, a surface on which the communication gateway 64 is mounted is referred to as a second surface S2.

As described above, the communication gateway 64 serving as an electrical component is mounted on the second surface S2 on a side opposite to the first surface S1 on which the receiving device 62 is mounted in the first bracket 81. From the point of allowing a larger number of pieces of equipment (the receiving device 62 and the communication gateway 64) to be collectively disposed with the use of one first bracket 81, as in the present embodiment, the receiving device 62 and the communication gateway 64 are desirably mounted respectively to the surfaces of the first bracket 81 on sides opposite to each other.

As illustrated in FIG. 8, the first coupling portion 812 is disposed to extend in the front-rear direction. A right end of the flat plate portion 811 is coupled to a rear end of the first coupling portion 812. A lower end portion of the first coupling portion 812 is bent leftward to configure a first bent portion 812D. In the first bent portion 812D, a plurality of first insertion holes 812Dp are provided. The first coupling portion 812 is disposed on the right side of the right pillar 452R.

The second coupling portion 813 is disposed to extend in the right-left direction. A left end of the flat plate portion 811 is coupled to a right end of the second coupling portion 813. A lower end portion of the second coupling portion 813 is bent forward to configure a second bent portion 813D. In the second bent portion 813D, a plurality of second insertion holes 813Dp (see FIG. 11) are provided. The second coupling portion 813 is disposed on the rear side of the right pillar 452R. Accordingly, the flat plate portion 811 coupled to the second coupling portion 813 is disposed on the right side relative to the left end portion of the right pillar 452R. As a result, the first bracket 81 is disposed as a whole to the right from the rear side of the right pillar 452R. That is, the first bracket 81 is disposed to be offset to the right side (the other side in the right-left direction) from the rear side of the right pillar 452R.

Such an arrangement of the first bracket 81 is desirable in terms of allowing reliable arrangement of the receiving device 62 mounted to the first bracket 81 at a position offset to the right side from the rear side of the right pillar 452R and at a position apart from the right pillar 452R. Further, the arrangement of the first bracket 81 described above is also desirable from the point of allowing the cable CA (for example, the data transmission cable CA-d (see FIG. 7)) to be easily routed to pass through the vicinity of the right pillar 452R.

Further, as illustrated in FIG. 8, in the arrangement in which the right end side of the flat plate portion 811 of the first bracket 81 is positioned relatively forward and the left end side thereof is positioned relatively rearward, the end portion of the first bracket 81 on the right side (the other side in the right-left direction) is disposed forward relative to the end portion thereof on the left side (the one side in the right-left direction). Here, the end portion of the first bracket 81 on the right side corresponds to a front end portion 812F that is most separated from the flat plate portion 811 in the first coupling portion 812. Meanwhile, the end portion of the first bracket 81 on the left side corresponds to a left end portion 813L that is most separated from the flat plate portion 811 in the second coupling portion 813.

Note that the first bracket 81 may be configured only of the flat plate portion 811 to be supported by the first support portion 91. In this case, the end portion of the first bracket 81 on the right side corresponds to the right end portion of the flat plate portion 811. Meanwhile, the end portion of the first bracket 81 on the left side corresponds to the left end portion of the flat plate portion 811.

From the viewpoint of easily disposing the receiving device 62 mounted on the first bracket 81 to the right side and the rear side relative to the right pillar 452R, as in the present embodiment, the first bracket 81 is desirably disposed to be inclined with respect to the front-rear direction. That is, the first bracket 81 is desirably disposed such that the end portion on the right side is positioned on the front side relative to the end portion on the left side.

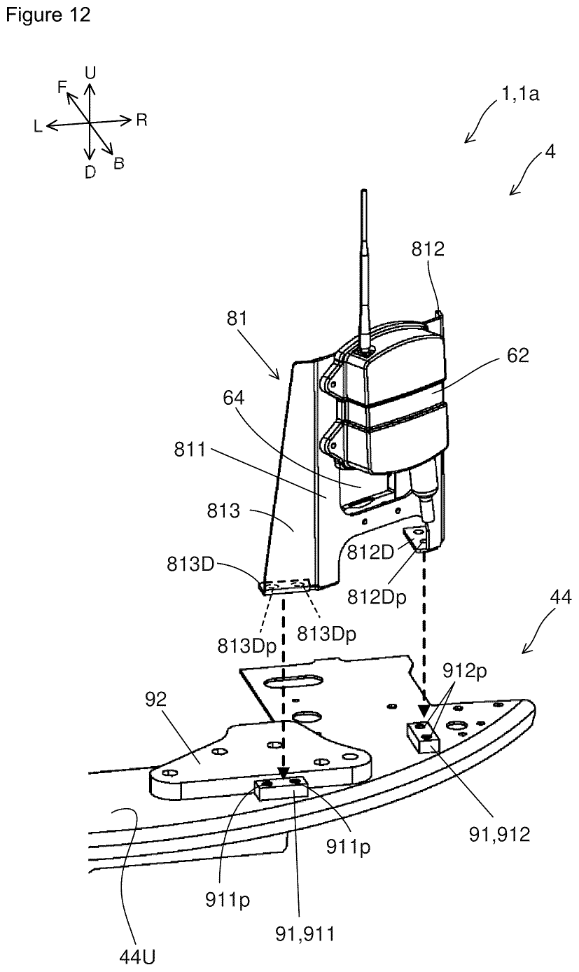

FIG. 12 is an exploded perspective view illustrating a state before the first bracket 81 is attached to the upper surface portion 44U of the machine room 44. At a predetermined position of the upper surface portion 44U, the first support portion 91 is fixed by welding or the like. The first support portion 91 is provided to support the first bracket 81 on the machine body 1a (in particular, the upper surface portion 44U of the upper revolving body 4).

The first support portion 91 includes a left first support portion 911 and a right first support portion 912. The left first support portion 911 and the right first support portion 912 are each configured of a block member made of metal. The left first support portion 911 and the right first support portion 912 are disposed apart from each other in the right-left direction on the upper surface portion 44U. In the left first support portion 911, a plurality of first support holes 911p through each of which a left attachment bolt B1 (see FIG. 8) is inserted are provided. In the right first support portion 912, a plurality of second support holes 912p through each of which a right attachment bolt B2 (see FIG. 8) is inserted are provided.

Further, at a predetermined position of the upper surface portion 44U, the second support portion 92 is fixed by using a fastening member such as a bolt. The second support portion 92 is provided to support the right pillar 452R serving as the second pillar on the machine body 1a (in particular, the upper surface portion 44U of the upper revolving body 4). A lower end portion of the right pillar 452R is fixed to the second support portion 92, for example, by welding or the like. The above-mentioned left first support portion 911 is provided adjacent to the second support portion 92 on the rear side of the second support portion 92 in the upper surface portion 44U. That is, the first support portion 91 includes the left first support portion 911 disposed adjacent to the second support portion 92 as an adjacent support portion. The right first support portion 912 is disposed on the right side relative to the second support portion 92.

A procedure for attaching the first bracket 81 to the machine body 1a (the upper surface portion 44U) is as follows. First, the first insertion hole 812Dp of the first bent portion 812D and the second support hole 912p of the right first support portion 912 are positionally aligned. Then, the right attachment bolt B2 (see FIG. 8) is inserted into the first insertion hole 812Dp and the second support hole 912p, and is fixed by using a nut. Further, the second insertion hole 813Dp of the second bent portion 813D and the first support hole 911p of the left first support portion 911 are positionally aligned. Then, the left attachment bolt B1 (see FIG. 8) is inserted into the second insertion hole 813Dp and the first support hole 911p, and is fixed by using a nut. This makes it possible to attach the first bracket 81 having the receiving device 62 and the communication gateway 64 mounted thereon to the upper surface portion 44U via the first support portion 91 (the left first support portion 911 and the right first support portion 912).

In order to stably support the first bracket 81 on the machine body 1a by the first support portion 91, the first support portion 91 is desirably disposed adjacent to the second support portion 92. Regarding this point, a configuration in which the first support portion 91 includes the left first support portion 911 serving as the adjacent support portion, and the left first support portion 911 is disposed adjacent to the second support portion 92 is desirable.

In particular, in the present embodiment, the contact area between the second support portion 92 and the upper surface portion 44U is larger than the contact area between the first support portion 91 and the upper surface portion 44U (see FIG. 12). Note that the contact area between the first support portion 91 and the upper surface portion 44U refers to a sum of the contact area between the left first support portion 911 and the upper surface portion 44U and the contact area between the right first support portion 912 and the upper surface portion 44U. In such a configuration in which the second support portion 92 is provided on the upper surface portion 44U, the second support portion 92 is more firmly and stably fixed to the upper surface portion 44U than the first support portion 91. Accordingly, the configuration in which the left first support portion 911 is disposed adjacent to the second support portion 92 is very effective in increasing the effect of stably supporting the first bracket 81 supported by the left first support portion 911 with respect to the machine body 1a.

Further, as illustrated in FIG. 8 and FIG. 9, from the viewpoint of reliably and stably supporting the first bracket 81 by the first support portion 91 on the left side relative to the alarm device 70, the first support portion 91 is desirably configured as follows. That is, the first support portion 91 desirably includes, in addition to the left first support portion 911 serving as the adjacent support portion, the right first support portion 912 as an auxiliary support portion. In addition, the right first support portion 912 (the auxiliary support portion) is desirably configured to be disposed between the left first support portion 911 (the adjacent support portion) and the alarm device 70.

### 6. Arrangement of Communication Device

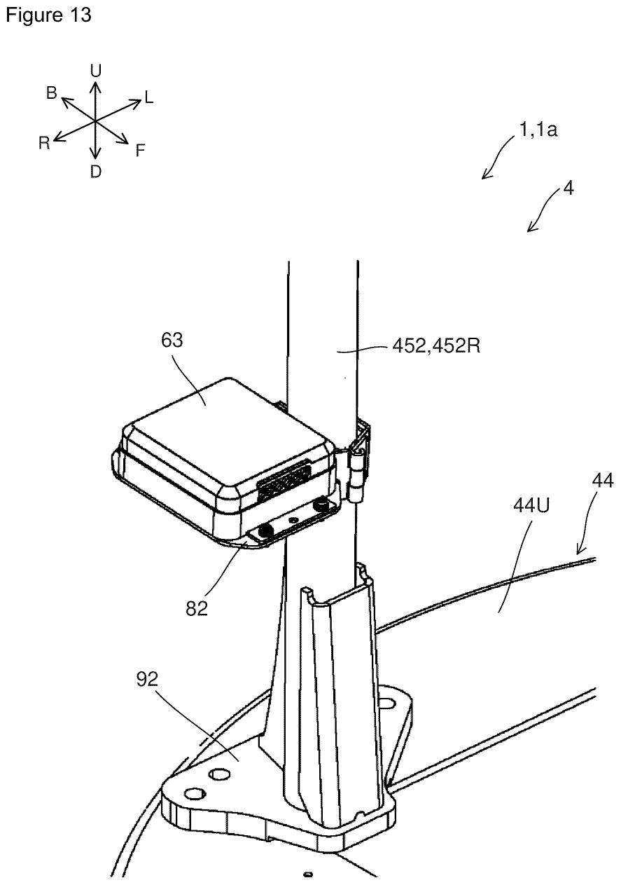

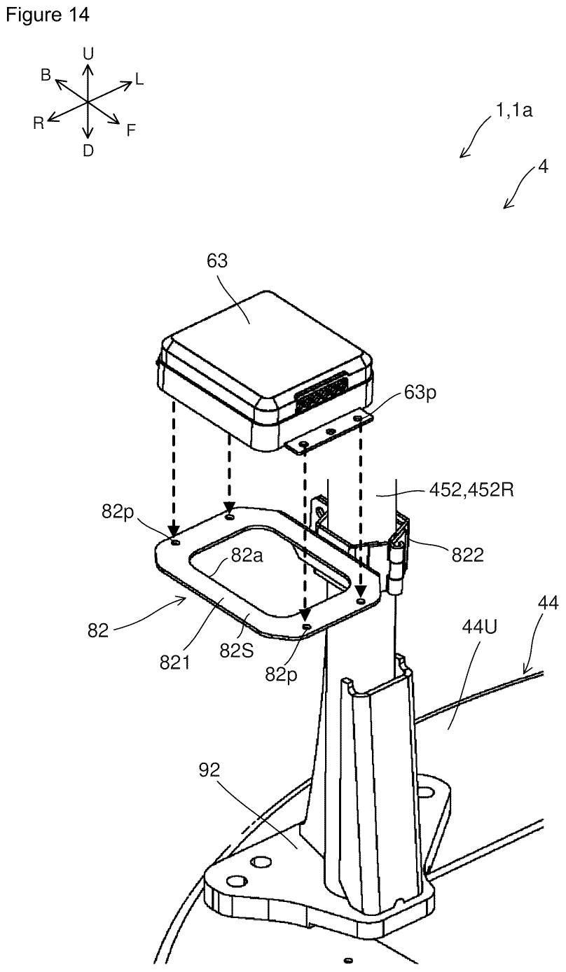

Next, the arrangement of the communication device 63 is described. FIG. 13 is a perspective view of the right pillar 452R as viewed from a right front side. As illustrated in the same figure, the communication device 63 is mounted to the second bracket 82. That is, the hydraulic excavator 1 includes the second bracket 82 on which the communication device 63 serving as predetermined equipment is mountable. The second bracket 82 is attached to the right pillar 452R. FIG. 14 is an exploded perspective view illustrating a state before the communication device 63 is attached to the second bracket 82.

The second bracket 82 is configured to include a support frame 821 and a clamp member 822. The support frame 821 is configured of, for example, a flat plate made of metal, and has an opening 82a at the middle. In the support frame 821, a plurality of hole portions 82p are formed at predetermined positions around the opening 82a. The communication device 63 is disposed above the support frame 821, and an attachment hole 63p of the communication device 63 and the hole portion 82p of the support frame 821 are positionally aligned. Then, a bolt (not shown) is inserted into the attachment hole 63p and the hole portion 82p and is fixed by using a nut. This allows the communication device 63 to be fixed to the support frame 821. That is, the communication device 63 is mounted to the second bracket 82.

The support frame 821 is positioned on the right side of the clamp member 822, and is provided integrally with the clamp member 822. Note that the support frame 821 may be configured to be fastened to the clamp member 822 by using a fastening member.

The clamp member 822 is a member that clamps the right pillar 452R. A position at which the right pillar 452R is clamped by the clamp member 822 (a clamp position) can be adjusted as appropriate in the up-down direction in which the right pillar 452R extends. With the clamp position being adjusted in the up-down direction, the positions in the up-down direction of the support frame 821 coupled to the clamp member 822 and the communication device 63 fixed to the support frame 821 can be adjusted.

As illustrated in FIG. 4, the second bracket 82 is mounted to the right pillar 452R above the first bracket 81 described above. With such an arrangement of the second bracket 82, an empty space is ensured below the second bracket 82. This allows the first bracket 81 to be disposed in the empty space, and a larger number of pieces of equipment (the receiving device 62, the communication device 63, and the communication gateway 64) to be collectively disposed around the right pillar 452R. Accordingly, from the point of allowing a larger number of pieces of equipment to be disposed in a compact manner, the configuration in which the second bracket 82 is mounted to the right pillar 452R above the first bracket 81 is desirable.

Further, when the second bracket 82 is disposed above the first bracket 81, the height position of the second bracket 82 can be adjusted, and the communication device 63 can be positioned at, for example, a position higher than the operator sitting on the driver's seat 41a. In this case, even when the operator sitting on the driver's seat 41a stretches his or her hand to the right side, the possibility that the operator's hand comes into contact with the communication device 63 mounted to the second bracket 82 is reduced. Also from this point, the configuration in which the second bracket 82 is mounted to the right pillar 452R above the first bracket 81 is desirable.

In the support frame 821, a surface on which the communication device 63 is mounted is referred to as an upper surface 82S (see FIG. 14) of the second bracket 82. In this case, the communication device 63 serving as predetermined equipment can be said as being mounted to the upper surface 82S of the second bracket 82.

As described above, when the communication device 63 is mounted to the upper surface 82S of the second bracket 82, the communication device 63 is stably supported from below by the second bracket 82. Further, when the communication device 63 communicates with the outside, there is no member inhibiting communication above the communication device 63, and hence the communication state is satisfactorily maintained. Moreover, for example, when the communication device 63 is mounted to a lower surface of the second bracket 82, depending on the height position of the second bracket 82, there is a possibility that the communication device 63 interferes with the first bracket 81 or equipment (the receiving device 62, the communication gateway 64) mounted to the first bracket 81. With the communication device 63 being mounted to the upper surface 82S of the second bracket 82, the possibility that the communication device 63 interferes with the first bracket 81 or the like is reduced.

### [7. Supplements]

The hydraulic excavator 1 is configured to include the engine 40 (see FIG. 1) as a prime mover, but the prime mover may be an electric motor.

The hydraulic excavator 1 may be configured to use both of hydraulic equipment such as the hydraulic actuator (for example, the hydraulic motor and the hydraulic cylinder) and an actuator to be driven by electric power. Examples of the actuator to be driven by electric power include an electric traveling motor, an electric cylinder, and an electric revolving motor.

In the present embodiment, as the working machine, the hydraulic excavator 1 has been described as an example, but the working machine is not limited to the hydraulic excavator 1, and may be a construction machine such as a mobile crane. Further, the working machine may have a configuration in which the upper body is not revolvable with respect to the lower body.

### 8. Clauses

The working machine (the hydraulic excavator 1) described in the present embodiment can be expressed as the following clauses.

A working machine according to clause (1) includes:
a pair of pillars that supports a canopy portion from a rear side of a driver's seat, the canopy portion being disposed above the driver's seat of a driving section provided on one side of a machine body in a right-left direction; and
a receiving device provided on the rear side relative to the pair of pillars, wherein:
the pair of pillars includes
   a first pillar disposed on the one side, and
   a second pillar disposed on an other side in the right-left direction relative to the first pillar; and
the receiving device is disposed to be offset to the other side from the rear side of the second pillar, and is disposed apart from the second pillar.

A working machine according to clause (2) is the working machine according to clause (1), wherein the receiving device is disposed on the other side relative to an end portion of the second pillar on the one side.

A working machine according to clause (3) is the working machine according to clause (1) or (2), further including a first bracket to which the receiving device is mounted,
wherein the first bracket is disposed between the second pillar and the receiving device to be supported on the machine body.

A working machine according to clause (4) is the working machine according to clause (3), wherein the first bracket is disposed to be offset to the other side from the rear side of the second pillar.

A working machine according to clause (5) is the working machine according to clause (3) or (4), wherein an end portion of the first bracket on the other side is disposed on a front side relative to an end portion of the first bracket on the one side.

A working machine according to clause (6) is the working machine according to clause (5), further including:
a first support portion that supports the first bracket on the machine body; and
a second support portion that supports the second pillar on the machine body,
wherein the first support portion includes an adjacent support portion disposed adjacent to the second support portion.

A working machine according to clause (7) is the working machine according to clause (6), further including an alarm device disposed on the other side relative to the second pillar,
wherein the first support portion includes an auxiliary support portion disposed between the adjacent support portion and the alarm device.

A working machine according to clause (8) is the working machine according to any one of clauses (3) to (6), further including a second bracket on which predetermined equipment (a communication device) is mountable,
wherein the second bracket is mounted to the second pillar above the first bracket.

A working machine according to clause (9) is the working machine according to clause (8), wherein the predetermined equipment is mounted on an upper surface of the second bracket.

A working machine according to clause (10) is the working machine according to clause (8) or (9), further including an electrical component (a communication gateway) that communicates with the predetermined equipment,
wherein the electrical component is mounted on a surface of the first bracket on a side opposite to a surface on which the receiving device is mounted.

The embodiment of the present invention has been described above, but the scope of the present invention is not limited thereto, and expansions or modifications can be made without departing from the gist of the invention.

### INDUSTRIAL APPLICABILITY

The present invention is applicable to a working machine such as a construction machine, for example.

### REFERENCE SIGNS LIST

1 . . . hydraulic excavator (working machine)
1a . . . machine body
2 . . . lower traveling body (machine body)
3 . . . working equipment
4 . . . upper revolving body (machine body)
41 . . . driving section
41a . . . driver's seat
62 . . . receiving device
63 . . . communication device (predetermined equipment)
64 . . . communication gateway (electrical component)
70 . . . alarm device
71 . . . alarm lamp (alarm device)
72 . . . alarm buzzer (alarm device)
81 . . . first bracket
82 . . . second bracket
82S . . . upper surface
91 . . . first support portion
92 . . . second support portion
451 . . . canopy portion
452 . . . pillar
452L . . . left pillar (pillar on one side in right-left direction)
452R . . . right pillar (pillar on other side in right-left direction)
812F . . . front end portion
813L . . . left end portion
911 . . . left first support portion (adjacent support portion)
912 . . . right first support portion (auxiliary support portion)
S1 . . . first surface
S2 . . . second surface

1: A working machine comprising:
a pair of pillars that supports a canopy portion from a rear side of a driver's seat, the canopy portion being disposed above the driver's seat of a driving section provided on one side of a machine body in a right-left direction; and
a receiving device provided on the rear side relative to the pair of pillars, wherein:
the pair of pillars includes a first pillar disposed on the one side, and
a second pillar disposed on an other side in the right-left direction relative to the first pillar; and
the receiving device is disposed to be offset to the other side from the rear side of the second pillar and is disposed apart from the second pillar.

2: The working machine according to claim 1, wherein the receiving device is disposed on the other side relative to an end portion of the second pillar on the one side.

3: The working machine according to claim 1, further comprising a first bracket to which the receiving device is mounted,
wherein the first bracket is disposed between the second pillar and the receiving device to be supported on the machine body.

4: The working machine according to claim 3, wherein the first bracket is disposed to be offset to the other side from the rear side of the second pillar.

5: The working machine according to claim 3, wherein an end portion of the first bracket on the other side is disposed on a front side relative to an end portion of the first bracket on the one side.

6: The working machine according to claim 5, further comprising:
a first support portion that supports the first bracket on the machine body; and
a second support portion that supports the second pillar on the machine body,
wherein the first support portion includes an adjacent support portion disposed adjacent to the second support portion.

7: The working machine according to claim 6, further comprising an alarm device disposed on the other side relative to the second pillar,
wherein the first support portion includes an auxiliary support portion disposed between the adjacent support portion and the alarm device.

8: The working machine according to claim 3, further comprising a second bracket on which predetermined equipment is mountable,
wherein the second bracket is mounted to the second pillar above the first bracket.

9: The working machine according to claim 8, wherein the predetermined equipment is mounted on an upper surface of the second bracket.

10: The working machine according to claim 8, further comprising an electrical component that communicates with the predetermined equipment,
wherein the electrical component is mounted on a surface of the first bracket on a side opposite to a surface on which the receiving device is mounted.
